(19) United States
(12) Patent Application Publication
(10) Pub. No.: US 2025/0053860 A1
(43) Pub. Date: Feb. 13, 2025

(54) SYSTEMS AND METHODS FOR IMPROVED ACTIVE LEARNING METHOD FOR MODEL DEVELOPMENT

(71) Applicant: Capital One Services, LLC, McLean, VA (US)

(72) Inventors: Jing ZHU, McLean, VA (US); Zhuqing ZHANG, McLean, VA (US); Erin BABINSKY, Vienna, VA (US); Yuhui TANG, Oakton, VA (US); Gang MEI, Ellicott City, MD (US)

(73) Assignee: Capital One Services, LLC, McLean, VA (US)

(21) Appl. No.: 18/446,460

(22) Filed: Aug. 8, 2023

(51) Int. Cl. G06N 20/00

(52) U.S. Cl. CPC G06N 20/00

(57) ABSTRACT

Methods and systems are described herein for minimizing resource expenditure during model training using user-defined constraints in sample selection. A system may obtain user-defined target parameter values for data labeling, a user input indicative of a value added per unit of model performance improvement, and a dataset (e.g., unlabeled samples). The system may select a first subset of the dataset and may transmit a request for labeling the samples. The system may receive a first training dataset comprising label data and the samples of the first subset. The system may train a machine learning model using the first training dataset and generate a margin curve. Based on the margin curve, the system may determine whether an amount of resource usage exceeds value added and responsive to determining that it does not exceed the amount of resource usage, select a second subset of the dataset.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, perform real-time determinations, and/or generate information (e.g., using generative AI).

However, despite these benefits and the wide-ranging number of potential applications, practical implementations of artificial intelligence have been hindered by several technical problems. First, artificial intelligence often relies on large amounts of high-quality data. The process for obtaining this data and ensuring it is high-quality is often complex, expensive, and time-consuming. Second, despite the mainstream popularity of artificial intelligence, practical implementations of artificial intelligence require specialized knowledge to design, program, and integrate artificial intelligence-based solutions, which limits the amount of people and resources available to create these practical implementations. Finally, results based on artificial intelligence are notoriously difficult to review as the process by which the results are made may be unknown or obscured. This obscurity creates hurdles for identifying errors in the results, as well as improving the models providing the results. These technical problems present an inherent problem with attempting to use an artificial intelligence-based solution for classification and generative applications.

### SUMMARY

Methods and systems are described herein for novel uses and/or improvements to artificial intelligence applications. As one example, methods and systems are described herein as a system for minimizing resource expenditure during model training using user-defined constraints in sample selection, such as by improving active learning techniques during model training.

There are many challenges that still exist in training machine learning models. For example, determining the correct sample size when training a machine learning model can be challenging because doing so often depends on a variety of factors, such as the complexity of the problem, the quality of the data, and the performance metrics of interest. For example, a larger sample size can reduce the variance of the model by providing more representative data, but it can also increase the bias if the data is not diverse enough. Determining the optimal sample size therefore requires balancing these two factors, which can be challenging.

Other challenges include collecting large amounts of high-quality data, which can be expensive and time-consuming, and which may limit the sample size that is practical for a given project. Additionally, some types of data, such as medical or financial data, may be difficult to obtain in large quantities due to privacy or regulatory concerns. Additionally or alternatively, the optimal sample size can vary depending on the complexity of the model being used. More complex models may require larger sample sizes to avoid overfitting, while simpler models may be able to generalize well with smaller sample sizes. Sample sizes required to achieve a certain level of performance can vary depending on the specific performance metrics of interest. For example, a model that requires high precision may need a larger sample size than a model that only requires high recall.

In view of these factors, the systems and methods relate to automatically determining the correct sample size for training a machine learning model based on a variety of aforementioned factors. However, correctly determining the sample size creates a novel technical problem of balancing the tradeoff between bias and variance, considering the cost and feasibility of obtaining data, accounting for model complexity, and choosing appropriate performance metrics for the problem at hand. To do so, the systems and methods generate a margin curve that helps to identify the threshold for making decisions that optimize a specific performance metric. For example, margin curves plot the distribution of predicted probabilities for a binary classification model (i.e., the probability that an instance belongs to the positive class) against a range of threshold values for classifying instances as positive or negative. By varying the threshold value, margin curves can help identify the point at which the model achieves optimal performance according to a specific performance metric, such as precision, recall, or F1-score. By examining the margin curve for the model, the system may identify the threshold probability value that maximizes precision, meaning that the model is most likely to accurately predict recommendations for sample sizes based on user-defined target parameter values. Overall, the systems and methods may provide better recommendations by helping to optimize the performance of a binary classification model based on a specific performance metric.

In some aspects, a system may minimize resource expenditure during model training using user-defined constraints in sample selection. For example, the system may obtain user-defined constraints and values, such as (1) one or more user-defined target parameter values for data labeling, (2) a user input indicative of a value added per unit of model performance improvement, and (3) a dataset comprising a plurality of unlabeled samples. The system may select a first subset of the dataset of samples of the plurality of unlabeled samples and may transmit a request for labeling the samples of the first subset, wherein the request comprises the samples of the first subset. The system may receive, from a device (e.g., a remote device, or a device connected to or including the system), a first training dataset based on the first subset, and may train, using the first training dataset, a machine learning model. The system may then generate, using the user input indicative of the value added per unit of model performance improvement, a margin curve of a relationship between resource usage and value added per unit of model performance improvement. Responsive to determining that the amount of value added does not exceed the amount of resource usage, the system may select a second subset of the dataset, wherein a number of samples of the second subset is determined based on the margin curve.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a system for minimizing resource expenditure during model training using user-defined constraints in sample selection, in accordance with one or more embodiments.

FIG. 2A shows an illustrative diagram of a user interface showing information regarding sample selection and model training, in accordance with one or more embodiments.

FIG. 2B shows an illustrative diagram of a user interface showing information regarding a margin curve, in accordance with one or more embodiments.

FIG. 3 shows illustrative components for a system used to minimize resource expenditure during model training using user-defined constraints in sample selection, in accordance with one or more embodiments.

FIG. 4 shows a flowchart of the steps involved in minimizing resource expenditure during model training using user-defined constraints in sample selection, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

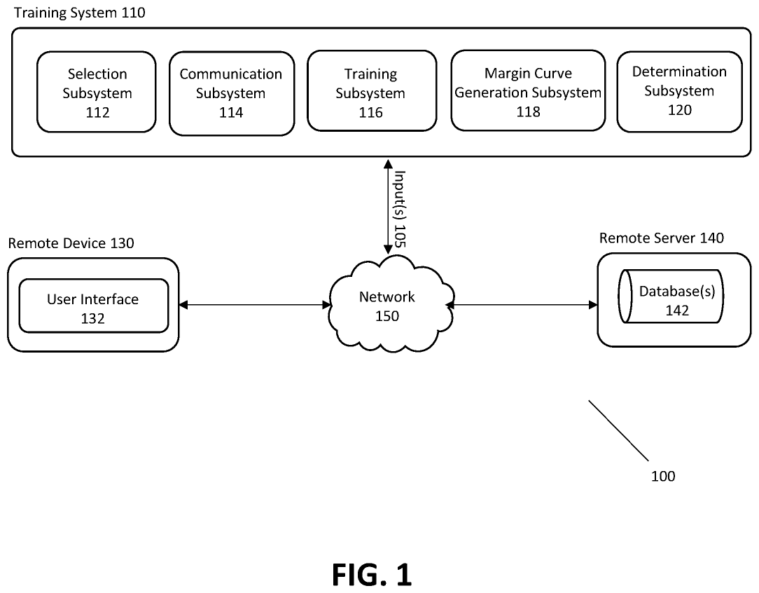

FIG. 1 is an example of environment 100 for minimizing resource expenditure during model training using user-defined constraints in sample selection, such as during active learning. For example, the environment 100 may be used to determine optimal sample set sizes for labeling while considering user-defined parameters such as value added and resource expenditure allotted during training.

According to some embodiments, the environment 100 may be used to improve active learning sampling techniques in order to optimize machine learning training performance. For example, in active learning, a machine learning model may be trained incrementally in a series of iterations. In each iteration of the active learning process, the most informative or uncertain samples are selected for labeling. The labeled samples are then used in the next iteration of training the machine learning model. As described herein, user-defined constraints can be used to optimize the active learning process by determining an optimal number of samples in each iteration as well as when to end the active learning process on a case-by-case basis based on the needs of the user and/or system that ultimately uses the model.

Environment 100 includes training system 110, remote device 130, remote server 140, and network 150. Training system 110, remote device 130, and remote server 140 may be in communication via the network 150. Network 150 may be a wired or wireless connection such as via a local area network, a wide area network (e.g., the Internet), or a combination thereof. The training system 110 may be used to minimize resource expenditure during model training using user-defined constraints in sample selection.

Training system 110 may receive one or more inputs 105 via communication subsystem 114. The one or more inputs 105 may include the user-defined constraints (e.g., which may be used in determining an optimal number of samples in each active learning iteration) or other data, such as the dataset to be used in training. A dataset may include, for example, a plurality of unlabeled samples, e.g., a number of which may be labeled during an active learning process. As described herein, the user-defined target parameter values may be used by the training system 110 to accurately predict recommendations for sample sizes for optimizing model training. For example, the user-defined constraints may include one or more user-defined target parameter values for data labeling and/or a user input indicative of a value added per unit of model performance improvement.

The one or more user-defined target parameter values for data labeling may include one or more values that define constraints that limit training to be in a particular way and/or may include values that define targets that indicate, for example, a value that should be optimized during training (e.g., such as a minimum or maximum threshold to meet once training is completed or during training). For example, one or more user-defined target parameter values may correspond to target parameters indicative of a threshold for bias and variance for the machine learning model. For example, in contexts that a low variance and low bias is desired, a user may indicate a threshold maximum variance or bias value of the model at the completion of training, or may indicate a target value that the system should optimize to when training the model.

Additionally or alternatively, obtaining one or more user-defined target parameter values further may include receiving a user selection of a target number of samples to be labeled from the plurality of unlabeled samples and determining, based on the target number of samples to be labeled from the plurality of unlabeled samples, a threshold number of samples for labeling. Additionally or alternatively, obtaining one or more user-defined target parameter values may include receiving a user selection of an upper limit of total cost associated with labeling the plurality of unlabeled samples and determining, based on the upper limit of total cost associated with labeling, a maximum number of samples to select for labeling. Similarly, obtaining one or more user-defined target parameter values may include receiving a user selection of target model complexity and a target model performance and determining, based on the user selection, a value added per unit of model performance improvement.

One or more inputs 105 may also include a user input indicative of a value added per unit of model performance. For example, the system may use a value added per unit of model performance to balance the cost of training with the benefits of the model after training. For example, if labeling cost is expensive, but the anticipated value is higher than the cost of labeling each label available, the system may choose to label all labels, however, if the cost of labeling is more than the anticipated value (e.g., benefit), the system may cease training.

The value may be a subjective or objective value to the user. For example, the value may be an anticipated business value of the model based on other data such as anticipated increase in revenue or reduction in costs against the costs of maintaining the model. The valuation may include and consider both direct and indirect impacts and can also include strategic value the model brings by providing market insights, competitive advantage, or future opportunities. For example, obtaining the user input indicative of the value added per unit of model performance improvement may include receiving a user selection of a user-defined valuation of the model performance improvement and determining, based on the user-defined valuation of the model performance improvement, the value added per unit of model performance improvement.

The unit of model performance improvement may include a unit of improvement in precision, recall, or F1-score, e.g., represented in fractional and/or percentage values. For example, the user input indicative of a value added per unit of model performance improvement may include (e.g., consider) a cost associated with labeling a sample of the plurality of unlabeled samples.

One or more inputs 105 may also include a dataset, e.g., comprising a plurality of unlabeled samples. For example, if the system were training a model on a dataset of customer reviews, each sample of the dataset may include a customer's written feedback but lack any specific categorization or sentiment label, such that they comprise unlabeled samples. The dataset could contain features such as the customer ID, product ID, review date, text of the review itself, and/or the like.

The user-defined constraints and/or dataset may be input by a user at a user device, such as remote device 130. As referred to herein, a remote device may include handheld mobile devices (e.g., smartphones, portable hotspots, tablets, etc.), a laptop, a wearable, a drone, a vehicle with wireless connectivity, a head-mounted display with wireless augmented reality/virtual reality (AR/VR) connectivity, a portable gaming console, wireless routers, gateways, modems, and other fixed-wireless access devices, wirelessly connected sensors that provides data to a remote server over a network, IoT devices such as wirelessly connected smart home appliances, etc. Although embodiments here describe a remote device, it may be appreciated that the remote device may be replaced by a device that is integrated with the training system 110 or connected to training system 110. For example, methods and techniques described herein may be performed using a device integrated with the training system 110 or connected to training system 110, rather than a remote device.

For example, the user interface 132 may be any suitable user interface and/or input device at which the user can indicate values, such as a keyboard, mouse, cursor interaction (e.g., click, hover, etc.). Alternatively or additionally, the remote device 130 may include a touchscreen and may receive touch selections or swipes indicating values for the one or more user-defined target parameter values for data labeling and user input indicative of a value added per unit of model performance improvement. The remote device 130 may also receive the values through speech recognition, voice commands, gesture recognition, and/or the like. The dataset may be uploaded, e.g., by a user via the remote device to the system.

Similarly, the dataset may be obtained from a database, such as database(s) 142 of remote server 140 to the system. The database(s) 142 may also store the one or more user-defined target parameter values for data labeling and/or the user input indicative of a value added per unit of model performance improvement and may be accessed by the system via communication subsystem 114 and/or network 150.

Once the communication subsystem 114 of the system receives the dataset of unlabeled samples, communication subsystem 114 may pass at least a portion of the dataset to the selection subsystem 112 of the training system 110. The selection subsystem 112 may be used to select subsets of the dataset including unlabeled samples, e.g., to request labels for those samples. In some examples, the selection subsystem 112 may select an initial subset (e.g., a first subset, a seed dataset) by randomly selecting unlabeled samples from the dataset. In other examples, the selection subsystem 112 may select a first subset of the dataset by selecting samples based on the one or more user-defined target parameter values (e.g., as described herein). For example, if the user-defined target parameter values included a target number of samples for labeling throughout the entire training process, e.g., 20000, the selection subsystem may choose a fraction of that number (e.g., 500), or make sure that the selected subset is of a size (e.g., number of samples) that does not exceed the target. In some examples, the user may select the size of the subset, or may be presented with a recommended size of the subset. The user may then indicate to proceed with the recommended size or input a new size to be used.

According to some examples, the system may use active learning, e.g., a diversity sampling method, to sample the seed dataset (e.g., the initial subset). For example, using diversity sampling may ensure a wide variety in the initial subset that is representative of the dataset. Some examples of techniques that may be used include representative sampling, cluster-based sampling, and/or the like. The system may also consider the user-identified constraints in selecting the subset. For example, the number of samples in the subset may be determined based on user-identified constraints, and the specific samples in the subset may be determined using a diversity sampling technique.

The selection subsystem 112 may then transmit the selected samples of the initial subset or identifiers of the selected samples of the initial subset to the communication subsystem. The communication subsystem may generate and/or transmit a request for labeling the samples of the initial (e.g., first) subset, where the request may include the selected samples or identifiers of the selected samples. Communication subsystem 114 may transmit the request via network 150 to a remote device 130, or to a remote server 140, for labeling. The labeling may be done manually, by one or more users at a remote device 130, or by users accessing the remote server 140. For example, if the model to be trained or being trained is a sentiment analysis model, the unlabeled subset may include excerpts of texts and one or more users may classify and label each sentiment analysis with a sentiment (e.g., “sad”, “happy”, “angry”, etc.). The communication subsystem may receive, in part or in whole, a first training dataset based on the initial subset of unlabeled samples. The first training dataset may include the unlabeled samples of the initial subset, as well as the label data, e.g., that users provided manually, where the label data indicates a classification for each sample.

Once the communication subsystem 114 of the system receives the first training dataset, communication subsystem 114 may pass at least a portion of the training dataset to the training subsystem 116 of the training system 110. The training subsystem 116 may train, using the first training dataset, a model, such as a machine learning model. For example, the training subsystem 116 may train a machine learning model in a first iteration of training using the first training dataset. The state of the parameters of the machine learning model may be stored (e.g., either locally, such as on a file on disk, or remotely, such as on the database of the remote server via communication subsystem 114).

The training system 110 may select a second subset of the dataset to continue training the model. In some examples, the training may include active learning techniques, where the labeling of unlabeled samples may include an iterative process that involves both a machine learning model and a human expert (or an oracle). For example, after training on the initial (e.g., first) dataset, the model may then make predictions on the unlabeled samples, and along with each prediction, may estimate its own uncertainty or confidence. The system (e.g., the selection subsystem of the training system) may select the samples from the unlabeled samples that the model is least certain of, based on the estimated uncertainty or confidence. In some examples, the number of samples of the second subset is determined based on a margin curve generated using the input of a user.

For example, the system may use the user input indicative of the value added per unit of model performance improvement to generate a margin curve of a relationship between resource usage and value added per unit of model performance improvement and determine, based on the margin curve, whether an amount of resource usage exceeds an amount of value added. As described herein, a user input indicative of a value added per unit of model performance may be an anticipated business value of the model for every increment of model performance (e.g., $10,000 for every percentage accuracy). The unit of model performance improvement may include a unit of improvement in precision, recall, or F1-score, e.g., represented in fractional and/or percentage values.

The communication subsystem 114 may pass the user input indicative of the value added per unit of model performance improvement to the margin curve generation subsystem 118. The margin curve generation subsystem 118 may generate a margin curve that shows a relationship between resource usage and value added per unit of model performance improvement. For example, the margin curve may show the relationship between labeling cost and the value added per unit of model performance improvement. For example, a labeling cost to obtain 10 classifications corresponding to the first 10 samples by a user may cost $10k and may provide a benefit in the accuracy of the model that is valued at $20k value. However, a labeling cost to obtain 30 classifications corresponding to the first 30 samples by a user may cost $30k and may only provide a benefit in the accuracy of the model that is valued at $25k value. This may indicate that labeling the 30 samples is not worth the cost, as the value of increasing the accuracy of the model is less than the cost.

The determination subsystem 120 may determine, based on the margin curve, whether an amount of resource usage exceeds an amount of value added. Responsive to determining that the amount of value added does not exceed the amount of resource usage, the determination subsystem may select a second subset of the dataset, wherein a number of samples of the second subset is determined based on the margin curve.

As described herein, the system may incorporate aspects of active learning, and selecting the second subset of the dataset may include determining, based on unlabeled samples of the dataset, a measure of uncertainty corresponding to each sample, wherein the measure is indicative of a confidence of the machine learning model in classifying each sample and identifying the samples of the plurality of unlabeled samples having a threshold measure of uncertainty. Responsive to determining that the amount of value added does not exceed the amount of resource usage, the selection subsystem 112 may select a second subset of the dataset, wherein a number of samples of the second subset is determined based on the margin curve.

The selection subsystem 112 may be used to select the second subset of the dataset including unlabeled samples. As described herein, an active learning process may be used, where the selection subsystem 112 selects the samples by selecting the samples for which the model yielded a lowest uncertainty. According to some examples, the number of samples selected for the second subset may be based on the margin curve.

The selection subsystem 112 may then transmit the selected samples of the second subset or identifiers of the selected samples of the second subset to the communication subsystem. The communication subsystem may generate and/or transmit a request for labeling the samples of the second subset, where the request may include the selected samples or identifiers of the selected samples. As described herein, the communication subsystem 114 may transmit the request via network 150 to a remote device 130, or to a remote server 140, for labeling. The labeling may be done manually, by one or more users at a remote device 130, or by users accessing the remote server 140. The communication subsystem may receive, in part or in whole, a second training dataset based on the second subset of unlabeled samples. The second training dataset may include the unlabeled samples of the second subset, as well as the label data, e.g., that users provided manually, where the label data indicates a classification for each sample.

Once the communication subsystem 114 of the system receives the second training dataset, communication subsystem 114 may pass at least a portion of the second training dataset to the training subsystem 116 of the training system 110. The training subsystem 116 may train, using the second training dataset, the previously trained machine learning model. For example, the training subsystem 116 may train a model in a second iteration of training using the second training dataset. For example, the training subsystem 116 may access the stored state of the parameters of the machine learning model (e.g., locally, or via the communication subsystem 114 and/or network 150 to obtain at least a portion of the parameters from the remote server and/or database. The parameters of the machine learning model may be updated by training on the second training dataset. Upon completion of training, the updated parameters may be stored (e.g., either locally, such as on a file on disk, or remotely, such as on the database of the remote server via communication subsystem 114).

Training system 110 may determine completion of training for the machine learning model based on the margin curve. For example, responsive to determining that the amount of value added exceeds the amount of resource usage, training system 110 may determine completion of training for the machine learning model. Once training is determined to be complete, the final state of the parameters may be stored and/or transmitted to an external device so it may be used in a different application, for example. For example, the system may generate one or more data files comprising parameters of the machine learning model in a standardized format and may transmit the one or more data files. For example, the system may transmit the one or more files to a remote device, such as remote device 130 or may transmit the one or more files to be stored on a remote server 140 and/or both.

Additionally or alternatively, the training system may use and/or execute the model locally. For example, training system may receive, e.g., from a remote device, one or more unseen samples (e.g., new samples never seen before) and generate one or more classifications for the one or more unseen samples using the machine learning model. The training system 110 may then transmit, to the remote device, the one or more classifications.

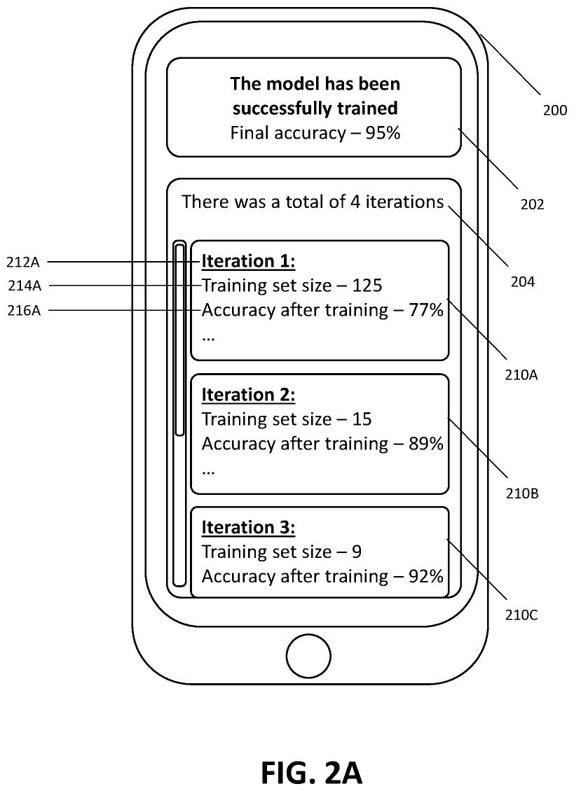

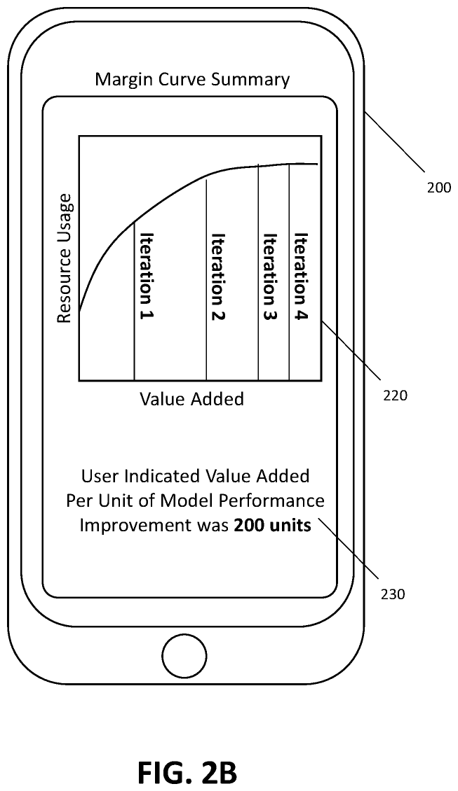

In some examples, once training is complete, the training system 110 may generate, for display on a user interface, a notification of completion of training of the machine learning model. For example, FIG. 2A shows an illustrative diagram of a notification of completion of training on a user interface. FIG. 2A also shows information regarding sample selection and model training, in accordance with one or more embodiments.

The notification and information may be provided on a user interface 132 of remote device 130. The remote device 130 may be a user's mobile device, for example. As described herein, the notification may be generated and provided in response to determining completion of training for the machine learning model (e.g., that the amount of value added exceeds the amount of resource usage).

In the example of FIG. 2A, the display 200 indicates to the user that the model has completed training with a message 202 “The model has been successfully trained.” The display may also indicate to the user how much time has been consumed for each iteration. The message 202 may also include metrics of the final model, such as the final accuracy (e.g., in this case, 95%). Further information may be provided to the user regarding the training process, such as the number of iterations, such as is indicated in message 204, “There was a total of 4 iterations,” and information regarding each iteration. For example, data regarding the first three iterations of active learning and training may be shown as portion 210A, portion 210B and portion 210C. Each of the portions may indicate the iteration number, the training set size, e.g., the number of samples, and the accuracy after training, and/or the like. For example, for portion 210A, text 212A indicates the first iteration (“Iteration 1”). Text 214A indicates that the training set size was 125 samples (“Training set size—125”), and text 216A indicates that the accuracy after training the first iteration was 77% (“Accuracy after training—77%”).

In some embodiments, the information provided on the display may also be provided after each iteration of training, e.g., to provide the user of an update throughout progress. For example, after the first iteration, the portion 210A may appear on the user interface, and after the second and third, the portion 210B and 210C may appear respectively. Once training has been completed, the notification in message 202 may appear with the full information on each training iteration provided to the user.

FIG. 2B shows an illustrative diagram of a user interface showing information regarding a margin curve, in accordance with one or more embodiments. The information regarding the margin curve may be provided on a user interface 132 of remote device 130. As described herein, the margin curve may be generated and provided in response to determining completion of training for the machine learning model (e.g., that the amount of value added exceeds the amount of resource usage). The display may show the generated margin curve 220, along with an indication of where each iteration falls on the margin curve. At the point defined by the fourth iteration, training ended because the margin curve plateaus, e.g., where the value added did not grow as resource usage increased. The diagram may also illustrate the value that the user indicated as value added per unit of model performance improvement in message 230, e.g., “Value Added Per Unit of Model Performance Improvement was 200 units.”

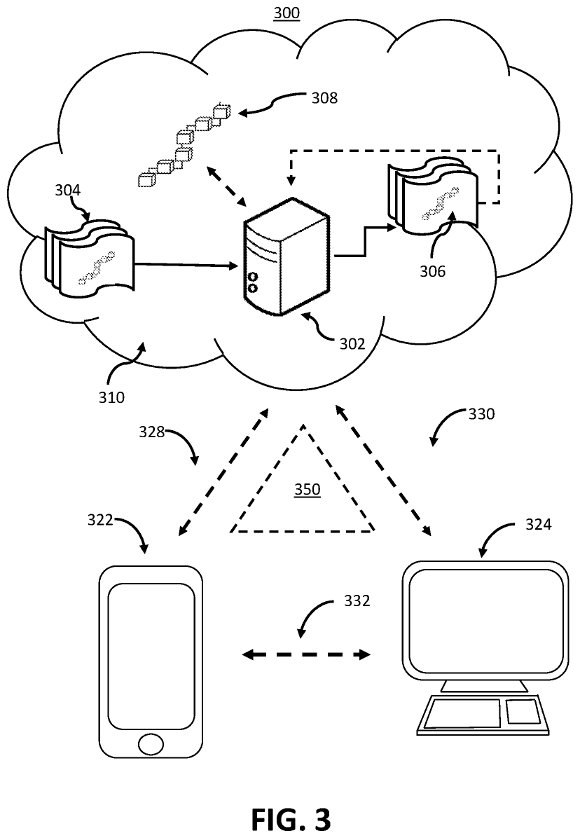

FIG. 3 shows illustrative components for a system used to minimize resource expenditure during model training using user-defined constraints in sample selection, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310.

Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as a touchscreen smartphones and a personal computer, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include training system 110, and components of training system 110, remote device 130, remote server 140, and/or network 150. Cloud components 310 may include model 302, which may be a machine learning model, AI model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train the model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., sensitive, non-sensitive information). The model 302 may also output a confidence measure for the classification.

In some embodiments, the model (e.g., model 302) may automatically perform actions based on outputs 306. In some embodiments, the model (e.g., model 302) may not perform any actions. The output of the model (e.g., model 302) may be used to minimize strain on computational capacity of preprocessors when analyzing multi-modal data in real-time.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front end and back end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC. Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

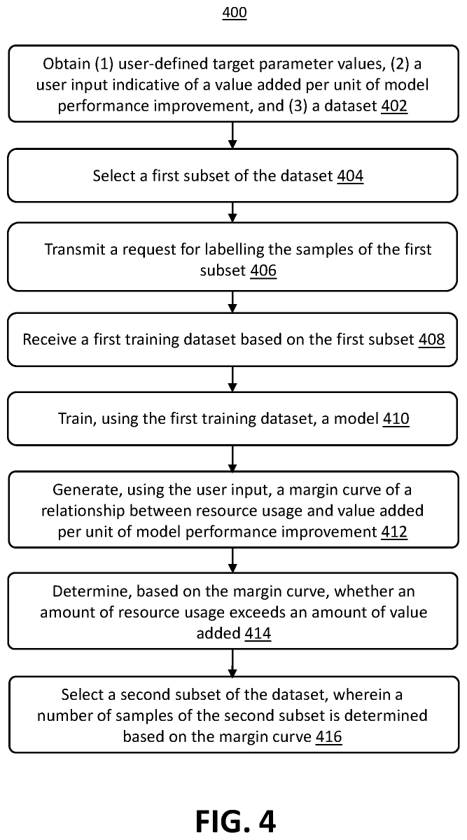

FIG. 4 shows a flowchart of the steps involved in the system for minimizing resource expenditure during model training using user-defined constraints in sample selection, in accordance with one or more embodiments. For example, the system may use process 400 (e.g., as implemented on one or more system components described above) for determining optimal sample sizes for labeling while considering user-defined parameters such as value and resource expenditure allotted.

At step 402, process 400 (e.g., using one or more components described above) includes obtaining user-defined constraints and values, such as (1) user-defined target parameter values, (2) a user input indicative of a value added per unit of model performance improvement, and (3) a dataset at step 402. For example, the system may obtain (e.g., receive, access, etc.) one or more user-defined target parameter values corresponding to target parameters indicative of a threshold for bias and variance for the machine learning model. By doing so, user-defined constraints can be used to optimize the active learning process by determining an optimal number of samples in each iteration as well as when to end the active learning process on a case-by-case basis based on the needs of the user and/or system that ultimately uses the model.

According to one embodiment, obtaining one or more user-defined target parameter values includes receiving a user selection of a target number of samples to be labeled from the plurality of unlabeled samples and determining, based on the target number of samples to be labeled from the plurality of unlabeled samples, a threshold number of samples for labeling. According to another embodiment, obtaining one or more user-defined target parameter values includes receiving a user selection of an upper limit of total cost associated with labeling the plurality of unlabeled samples and determining, based on the upper limit of total cost associated with labeling, a maximum number of samples to select for labeling. According to some embodiments, obtaining one or more user-defined target parameter values includes receiving a user selection of target model complexity and a target model performance and determining, based on the user selection, a value added per unit of model performance improvement.

At step 404, process 400 (e.g., using one or more components described above) includes selecting a first subset of the dataset, e.g., wherein the first subset comprises samples of the plurality of unlabeled samples. As described herein, in some examples, selecting a first subset may include randomly selecting unlabeled samples from the dataset. In other examples, doing so may include selecting a first subset of the dataset by selecting samples based on the one or more user-defined target parameter values. For example, if the user-defined target parameter values included a target number of samples for labeling throughout the entire training process, e.g., 20000, the selection subsystem may choose a fraction of that number (e.g., 10000), or make sure that the selected subset is of a size (e.g., number of samples) that does not exceed the target.

At step 406, process 400 (e.g., using one or more components described above) includes transmitting a request for labeling the samples of the first subset. In some examples, the request may include the samples of the first subset. Alternatively or additionally, the request may include the identifiers of the samples. By doing so, samples chosen based on user-defined constraints can be used during training so that each iteration of training is optimized.

At step 408, process 400 includes receiving a first training dataset based on the first subset. For example, at step 408 the system may receive, from the remote device, a first training dataset based on the first subset, wherein the first training dataset comprises label data and the samples of the first subset, and wherein the label data indicates a classification for each sample. At step 410, process 400 (e.g., using one or more components described above) includes training, using the first training dataset, a model.

At step 412, process 400 (e.g., using one or more components described above) includes generating, using the user input, a margin curve of a relationship between resource usage and value added per unit of model performance improvement. For example, the system may use the user input indicative of the value added per unit of model performance improvement, to generate the margin curve. By doing so, the system may determine whether or not continuing training and what number of labels are needed for training for a specific model and the specific use case for the model.

At step 414, process 400 (e.g., using one or more components described above) includes, determining, based on the margin curve, whether an amount of resource usage exceeds an amount of value added. At step 416, process 400 includes selecting a second subset of the dataset, wherein a number of samples of the second subset is determined based on the margin curve. In some examples, the system may select the second subset of the dataset responsive to determining that the amount of value added does not exceed the amount of resource usage.

According to some examples, selecting the second subset of the dataset may include determining, based on unlabeled samples of the dataset, a measure of uncertainty corresponding to each sample, wherein the measure is indicative of a confidence of the machine learning model in classifying each sample and identifying the samples of the plurality of unlabeled samples having a threshold measure of uncertainty.

In some embodiments, once the second subset has been selected, the process may further include transmitting, e.g., to a remote device, a second request for labeling samples of the second subset, wherein the second request comprises samples of the second subset. Responsive to the second request, the system may receive, e.g., from a remote device, a second training dataset based on the second subset, wherein the second training dataset comprises label data and the samples of the second subset, and wherein the label data indicates a classification for each sample. The system may then update, using the second training dataset, the machine learning model.

According to some embodiments, responsive to determining that the amount of value added exceeds the amount of resource usage, the system may determine completion of training for the machine learning model. The system may then generate, for display on a user interface, a notification of completion of training of the machine learning model. Alternatively, the system may generate one or more data files comprising parameters of the machine learning model in a standardized format and transmit, to a remote device, the one or more data files.

In some embodiments, the system may use and/or execute the trained model on new, unseen samples. For example, the system may receive, such as from a remote device, one or more unseen samples and may generate one or more classifications for the one or more unseen samples using the machine learning model. The system may transmit, e.g., to a remote device, the one or more classifications.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

The present techniques will be better understood with reference to the following enumerated embodiments:
1. A method for minimizing resource expenditure during model training using user-defined constraints in sample selection, the method comprising: obtaining (1) one or more user-defined target parameter values for data labeling. (2) a user input indicative of a value added per unit of model performance improvement, and (3) a dataset comprising a plurality of unlabeled samples; selecting a first subset of the dataset, wherein the first subset comprises samples of the plurality of unlabeled samples; transmitting, to a remote device, a request for labeling the samples of the first subset, wherein the request comprises the samples of the first subset; receiving, from the remote device, a first training dataset based on the first subset, wherein the first training dataset comprises label data and the samples of the first subset, and wherein the label data indicates a classification for each sample; training, using the first training dataset, a machine learning model; generating, using the user input indicative of the value added per unit of model performance improvement, a margin curve of a relationship between resource usage and value added per unit of model performance improvement; determining, based on the margin curve, whether an amount of resource usage exceeds an amount of value added; and responsive to determining that the amount of value added does not exceed the amount of resource usage, selecting a second subset of the dataset, wherein a number of samples of the second subset is determined based on the margin curve.
2. The method of any one of the preceding embodiments, further comprising: transmitting, to the remote device, a second request for labeling samples of the second subset, wherein the second request comprises samples of the second subset; receiving, from the remote device, a second training dataset based on the second subset, wherein the second training dataset comprises label data and the samples of the second subset, and wherein the label data indicates a classification for each sample; and updating, using the second training dataset, the machine learning model.
3. The method of any one of the preceding embodiments, further comprising: responsive to determining that the amount of value added exceeds the amount of resource usage, determining completion of training for the machine learning model; and generating, for display on a user interface, a notification of completion of training of the machine learning model.
4. The method of any one of the preceding embodiments, further comprising: responsive to determining that the amount of value added exceeds the amount of resource usage, determining completion of training for the machine learning model; generating one or more data files comprising parameters of the machine learning model in a standardized format; and transmitting, to a remote device, the one or more data files.
5. The method of any one of the preceding embodiments, further comprising: responsive to determining that the amount of value added exceeds the amount of resource usage, determining completion of training for the machine learning model; receiving, from a remote device, one or more unseen samples; generating one or more classifications for the one or more unseen samples using the machine learning model; and transmitting, to a remote device, the one or more classifications.
6. The method of any one of the preceding embodiments, wherein selecting the second subset of the dataset comprises: determining, based on unlabeled samples of the dataset, a measure of uncertainty corresponding to each sample, wherein the measure is indicative of a confidence of the machine learning model in classifying each sample; and identifying the samples of the plurality of unlabeled samples having a threshold measure of uncertainty.
7. The method of any one of the preceding embodiments, wherein selecting a first subset of the dataset comprises selecting samples based on the one or more user-defined target parameter values.
8. The method of any one of the preceding embodiments, wherein the one or more user-defined target parameter values correspond to target parameters indicative of a threshold for bias and variance for the machine learning model.
9. The method of any one of the preceding embodiments, wherein the unit of model performance improvement comprises a unit of improvement in precision, recall, or F1-score, and wherein the user input indicative of a value added per unit of model performance improvement comprises a cost associated with labeling a sample of the plurality of unlabeled samples.
10. The method of any one of the preceding embodiments, wherein obtaining the user input indicative of the value added per unit of model performance improvement further comprises: receiving a user selection of a user-defined valuation of the model performance improvement; and determining, based on the user-defined valuation of the model performance improvement, the value added per unit of model performance improvement.
11. The method of any one of the preceding embodiments, wherein obtaining one or more user-defined target parameter values further comprises: receiving a user selection of a target number of samples to be labeled from the plurality of unlabeled samples; and determining, based on the target number of samples to be labeled from the plurality of unlabeled samples, a threshold number of samples for labeling.
12. The method of any one of the preceding embodiments, wherein obtaining one or more user-defined target parameter values further comprises: receiving a user selection of an upper limit of total cost associated with labeling the plurality of unlabeled samples; and determining, based on the upper limit of total cost associated with labeling, a maximum number of samples to select for labeling.
13. The method of any one of the preceding embodiments, wherein obtaining one or more user-defined target parameter values further comprises: receiving a user selection of target model complexity and a target model performance; and determining, based on the user selection, a value added per unit of model performance improvement.
14. A tangible, non-transitory, machine-readable medium storing instructions that, when executed by a data processing apparatus, cause the data processing apparatus to perform operations comprising those of any of embodiments 1-13.
15. A system comprising one or more processors; and memory-storing instructions that, when executed by the processors, cause the processors to effectuate operations comprising those of any of embodiments 1-13.
16. A system comprising a mobile device comprising one or more processors; and a non-transitory computer readable medium comprising instructions recorded thereon that when executed by the one or more processors cause operations for performing any of embodiments 1-13.

What is claimed is:

1. A system for minimizing resource usage during model training using user-defined constraints in sample selection, the system comprising:
a mobile device comprising one or more processors; and
a non-transitory computer readable medium comprising instructions recorded thereon that when executed by the one or more processors causes operations comprising:
obtaining (1) one or more user-defined target parameter values for data labeling, (2) a user input indicative of a value added per unit of model performance improvement, and (3) a dataset comprising a plurality of unlabeled samples;
selecting, based on the one or more user-defined target parameter values, a first subset of the dataset, wherein the first subset comprises samples of the plurality of unlabeled samples;
transmitting, to a remote device, a request for labeling the samples of the first subset, wherein the request comprises the samples of the first subset;
receiving, from the remote device, a first training dataset based on the first subset, wherein the first training dataset comprises label data and the samples of the first subset, and wherein the label data indicates a classification for each sample;
training, using the first training dataset, a machine learning model;
generating, using the user input indicative of the value added per unit of model performance improvement, a margin curve of a relationship between resource usage and value added per unit of model performance improvement;
determining, based on the margin curve, whether an amount of resource usage exceeds an amount of value added;
responsive to determining that the amount of value added does not exceed the amount of resource usage, selecting a second subset of the dataset, wherein a number of samples of the second subset is determined based on the margin curve;
transmitting, to the remote device, a second request for labeling samples of the second subset, wherein the second request comprises samples of the second subset;
receiving, from the remote device, a second training dataset comprising label data and the samples of the second subset; and
updating, using the second training dataset, the machine learning model.

2. A method for minimizing resource expenditure during model training using user-defined constraints in sample selection, the method comprising:
obtaining (1) one or more user-defined target parameter values for data labeling, (2) a user input indicative of a value added per unit of model performance improvement, and (3) a dataset comprising a plurality of unlabeled samples;
selecting a first subset of the dataset, wherein the first subset comprises samples of the plurality of unlabeled samples;
transmitting, to a remote device, a request for labeling the samples of the first subset, wherein the request comprises the samples of the first subset;
receiving, from the remote device, a first training dataset based on the first subset, wherein the first training dataset comprises label data and the samples of the first subset, and wherein the label data indicates a classification for each sample;
training, using the first training dataset, a machine learning model;
generating, using the user input indicative of the value added per unit of model performance improvement, a margin curve of a relationship between resource usage and value added per unit of model performance improvement;
determining, based on the margin curve, whether an amount of resource usage exceeds an amount of value added; and
responsive to determining that the amount of value added does not exceed the amount of resource usage, selecting a second subset of the dataset, wherein a number of samples of the second subset is determined based on the margin curve.

3. The method of claim 2, further comprising:
transmitting, to the remote device, a second request for labeling samples of the second subset, wherein the second request comprises samples of the second subset;
receiving, from the remote device, a second training dataset based on the second subset, wherein the second training dataset comprises label data and the samples of the second subset, and wherein the label data indicates a classification for each sample; and
updating, using the second training dataset, the machine learning model.

4. The method of claim 3, further comprising:
responsive to determining that the amount of value added exceeds the amount of resource usage, determining completion of training for the machine learning model; and
generating, for display on a user interface, a notification of completion of training of the machine learning model.

5. The method of claim 3, further comprising:
responsive to determining that the amount of value added exceeds the amount of resource usage, determining completion of training for the machine learning model;
generating one or more data files comprising parameters of the machine learning model in a standardized format; and
transmitting, to a remote device, the one or more data files.

6. The method of claim 3, further comprising:
responsive to determining that the amount of value added exceeds the amount of resource usage, determining completion of training for the machine learning model;
receiving, from a remote device, one or more unseen samples;
generating one or more classifications for the one or more unseen samples using the machine learning model; and
transmitting, to a remote device, the one or more classifications.

7. The method of claim 3, wherein selecting the second subset of the dataset comprises:
determining, based on unlabeled samples of the dataset, a measure of uncertainty corresponding to each sample, wherein the measure is indicative of a confidence of the machine learning model in classifying each sample; and
identifying the samples of the plurality of unlabeled samples having a threshold measure of uncertainty.

8. The method of claim 2, wherein selecting a first subset of the dataset comprises selecting samples based on the one or more user-defined target parameter values.

9. The method of claim 2, wherein the one or more user-defined target parameter values correspond to target parameters indicative of a threshold for bias and variance for the machine learning model.

10. The method of claim 2, wherein the unit of model performance improvement comprises a unit of improvement in precision, recall, or F1-score, and wherein the user input indicative of a value added per unit of model performance improvement comprises a cost associated with labeling a sample of the plurality of unlabeled samples.

11. The method of claim 2, wherein obtaining the user input indicative of the value added per unit of model performance improvement further comprises:
receiving a user selection of a user-defined valuation of the model performance improvement; and
determining, based on the user-defined valuation of the model performance improvement, the value added per unit of model performance improvement.

12. The method of claim 2, wherein obtaining one or more user-defined target parameter values further comprises:
receiving a user selection of a target number of samples to be labeled from the plurality of unlabeled samples; and
determining, based on the target number of samples to be labeled from the plurality of unlabeled samples, a threshold number of samples for labeling.

13. The method of claim 2, wherein obtaining one or more user-defined target parameter values further comprises:
receiving a user selection of an upper limit of total cost associated with labeling the plurality of unlabeled samples; and
determining, based on the upper limit of total cost associated with labeling, a maximum number of samples to select for labeling.

14. The method of claim 2, wherein obtaining one or more user-defined target parameter values further comprises:
receiving a user selection of target model complexity and a target model performance; and
determining, based on the user selection, a value added per unit of model performance improvement.

15. One or more non-transitory computer readable media for minimizing resource expenditure during model training using user-defined constraints in sample selection, storing instructions that, when executed by one or more processors, cause the one or more processors to perform operations comprising:
obtaining (1) one or more user-defined target parameter values for data labeling, (2) a user input indicative of a value added per unit of model performance improvement, and (3) a dataset comprising a plurality of unlabeled samples;
selecting a first subset of the dataset, wherein the first subset comprises samples of the plurality of unlabeled samples;
transmitting, to a remote device, a request for labeling the samples of the first subset, wherein the request comprises the samples of the first subset;
receiving, from the remote device, a first training dataset based on the first subset, wherein the first training dataset comprises label data and the samples of the first subset, and wherein the label data indicates a classification for each sample;
training, using the first training dataset, a machine learning model;
generating, using the user input indicative of the value added per unit of model performance improvement, a margin curve of a relationship between resource usage and value added per unit of model performance improvement;
determining, based on the margin curve, whether an amount of resource usage exceeds an amount of value added; and
responsive to determining that the amount of value added does not exceed the amount of resource usage, selecting a second subset of the dataset, wherein a number of samples of the second subset is determined based on the margin curve.

16. The one or more non-transitory computer readable media of claim 15, wherein the instructions cause the one or more processors to perform operations comprising:
transmitting, to the remote device, a second request for labeling samples of the second subset, wherein the second request comprises samples of the second subset;
receiving, from the remote device, a second training dataset based on the second subset, wherein the second training dataset comprises label data and the samples of the second subset, and wherein the label data indicates a classification for each sample; and
updating, using the second training dataset, the machine learning model.

17. The one or more non-transitory computer readable media of claim 16, wherein the instructions cause the one or more processors to perform operations comprising:
responsive to determining that the amount of value added exceeds the amount of resource usage, determining completion of training for the machine learning model; and
generating, for display on a user interface, a notification of completion of training of the machine learning model.

18. The one or more non-transitory computer readable media of claim 16, wherein the instructions cause the one or more processors to perform operations comprising:
responsive to determining that the amount of value added exceeds the amount of resource usage, determining completion of training for the machine learning model;
generating one or more data files comprising parameters of the machine learning model in a standardized format; and
transmitting, to a remote device, the one or more data files.

19. The one or more non-transitory computer readable media of claim 16, wherein the instructions cause the one or more processors to perform operations comprising:
responsive to determining that the amount of value added exceeds the amount of resource usage, determining completion of training for the machine learning model;
receiving, from a remote device, one or more unseen samples;
generating one or more classifications for the one or more unseen samples using the machine learning model; and
transmitting, to a remote device, the one or more classifications.

20. The one or more non-transitory computer readable media of claim 16, wherein the instructions cause the one or more processors to perform operations comprising:
determining, based on unlabeled samples of the dataset, a measure of uncertainty corresponding to each sample, wherein the measure is indicative of a confidence of the machine learning model in classifying each sample; and
identifying the samples of the plurality of unlabeled samples having a threshold measure of uncertainty.
